(19) United States
(12) Patent Application Publication
(10) Pub. No.: US 2013/0268177 A1
(43) Pub. Date: Oct. 10, 2013

(54) INDIVIDUAL CYLINDER FUEL AIR RATIO ESTIMATION FOR ENGINE CONTROL AND ON-BOARD DIAGNOSIS

(71) Applicants: Zhijian James Wu, Rochester Hills, MI (US); Paula M. Reeber-Schmanski, Howell, MI (US); Richard A. Kulas, Dexter, MI (US); Jay C. McCombie, Rochester Hills, MI (US); Gregory L. Ohl, Ann Arbor, MI (US)

(72) Inventors: Zhijian James Wu, Rochester Hills, MI (US); Paula M. Reeber-Schmanski, Howell, MI (US); Richard A. Kulas, Dexter, MI (US); Jay C. McCombie, Rochester Hills, MI (US); Gregory L. Ohl, Ann Arbor, MI (US)

(73) Assignee: CHRYSLER GROUP LLC, Auburn Hills, MI (US)

(21) Appl. No.: 13/440,126

(22) Filed: Apr. 5, 2012

(51) Int. Cl. G01M 15/04; F02D 41/00

(52) U.S. Cl. 701/103; 73/114.72

(57) ABSTRACT

A method of estimating the individual fuel air ratio richness of an individual cylinder in an engine by utilizing a single oxygen sensor at the confluence of a plurality of exhaust runners. The method provides for the use of a wide range or switching oxygen sensor at the confluence of a plurality of exhaust runners.

### FIELD

The present disclosure relates to a fuel air richness estimation method, more particularly, to a fuel air richness estimation method for an internal combustion engine having a plurality of engine cylinders.

### BACKGROUND

It is desirable in modern internal combustion engines to achieve high fuel economy and low engine emissions. However, the balance between high fuel economy and low, environmentally harmful, engine emissions can be a challenging task for engine designers. Part of this challenge is achieving a desired ratio between the amount of air and the amount of fuel (“fuel air ratio”) that enters an engine cylinder. This challenge is compounded by the fact that the fuel air ratio must be controlled to the desired ratio for each of a plurality of engine cylinders. A fuel air ratio imbalance between the plurality of engine cylinders will result in poor fuel economy and excessive undesirable vehicle emissions. Government regulations are beginning to require automobiles featuring internal combustion engines to maintain the fuel air ratio imbalance between the plurality of engine cylinders below a certain threshold to better control the engine's emissions.

Prior art methods teach controlling the fuel air ratio imbalance between engine cylinders by employing a wide range oxygen sensor in the individual exhaust runner of each cylinder. However, installing an individual wide range oxygen sensor in each cylinder exhaust runner is expensive and time consuming. Wide range oxygen sensors are expensive as is the labor needed to install them in each exhaust runner. Another way to estimate the fuel air ratio for each cylinder is to install an oxygen sensor at the confluence point of the exhaust runners in the exhaust manifold. The performance and complexity of this technique highly depend on the estimation methods and techniques used, the design of the manifold, and location of the sensor. Most published methods require an expensive wide range oxygen sensor installed at the confluence point of the exhaust runners and high computational resources. These methods typically fail to directly estimate the value of the fuel air ratio for each cylinder, rendering them difficult to use with vehicle on board diagnostics (“OBD”). Moreover, many prior art methods include a complicated calibration process. Further, typical prior art methods require substantial computing power to complete the estimation, but are unable to accurately estimate the fuel air ratio for each cylinder.

What is needed, therefore, is a method of measuring the fuel air ratio of each cylinder that effectively estimates the fuel air ratio of individual cylinders by utilizing a single oxygen sensor located at the confluence point of the runners. What is also needed is a method that is compatible with a wide range oxygen sensor and, generally lower cost, switching oxygen sensors. What is further needed is a method that directly estimates the value of the fuel air ratio for each cylinder, that is compatible with vehicle on board diagnostics, and includes a simplified calibration process. What is also needed is a method to more accurately estimate the fuel air ratio for each cylinder that requires reduced computing power to complete the estimation.

### SUMMARY

In one form, the present disclosure provides a method of estimating fuel richness of a plurality of engine cylinders. The method includes providing a first oxygen sensor at a confluence of a plurality of exhaust runners associated with the engine cylinders, gathering data regarding an actual fuel air ratio at the confluence of the plurality of exhaust runners using the first oxygen sensor, and forming a signal array for each of the plurality of engine cylinders using the data gathered by the first oxygen sensor. The method also includes calculating individual fuel richness for each of the plurality of engine cylinders using an individual cylinder fuel richness estimator.

In another form, the present disclosure provides a method of estimating fuel richness of an engine including providing a first oxygen sensor at a confluence of a plurality of exhaust runners associated with a plurality of engine cylinders and determining an angular position of a crankshaft of the engine. The method also includes gathering data regarding an actual fuel air ratio at the confluence of the plurality of exhaust runners using the first oxygen sensor when the crankshaft is at a predetermined rotational position. The data gathered at the predetermined rotational position corresponds to one of the plurality of engine cylinders. The method also includes forming a signal array for each of the plurality of engine cylinders using the corresponding data gathered by the first oxygen sensor, and calculating an individual fuel richness for each of the plurality of engine cylinders using an individual fuel richness estimator.

Thus, a method of measuring the fuel air ratio of each cylinder that effectively estimates the fuel air ratio of individual cylinders from the measurement of an oxygen sensor located at the confluence point of the exhaust runners is described. The method is compatible with both a wide range oxygen sensor and a switching oxygen sensor. The method directly estimates the value of the fuel air ratio for each cylinder, is compatible with vehicle on board diagnostics, and includes a simplified calibration process. Further, the method accurately estimates the fuel air ratio for each cylinder and requires reduced computing power to complete the estimation.

Further areas of applicability of the present disclosure will become apparent from the detailed description and claims provided hereinafter. It should be understood that the detailed description, including disclosed embodiments and drawings, are merely exemplary in nature intended for purposes of illustration only and are not intended to limit the scope of the invention, its application or use. Thus, variations that do not depart from the gist of the invention are intended to be within the scope of the invention.

### BRIEF DESCRIPTION OF THE DRAWINGS

FIG. 1 is a schematic representation of an exemplary exhaust system having an exhaust manifold, a wide range oxygen sensor in each exhaust runner, and a switching or wide range oxygen sensor at the confluence of the exhaust runners;

FIG. 2 is a schematic representation of an exemplary exhaust system having an exhaust manifold and a switching or wide range oxygen sensor at the confluence of the exhaust runners;

FIG. 3 is a flowchart showing an exemplary fuel air ratio estimation method;

FIG. 4 is a flowchart showing an exemplary individual cylinder fuel richness estimation step for the method of FIG. 3;

FIG. 5 is a flowchart showing an exemplary system block for the signal array formation step and individual cylinder neural network fuel richness estimators step of the method of FIG. 4;

FIG. 6 is a flowchart showing an exemplary system block for the signal array formation step and an individual cylinder linear fuel richness estimators step of the method of FIG. 4;

FIG. 7 is a plot showing oxygen sensor, engine RPM, and manifold pressure signals for an exemplary engine; and

FIG. 8 is a plot showing the estimated and actual individual cylinder fuel richness of engine cylinders 2, 4, 6 of the engine of FIG. 7 using the method of FIGS. 3 and 6.

### DETAILED DESCRIPTION

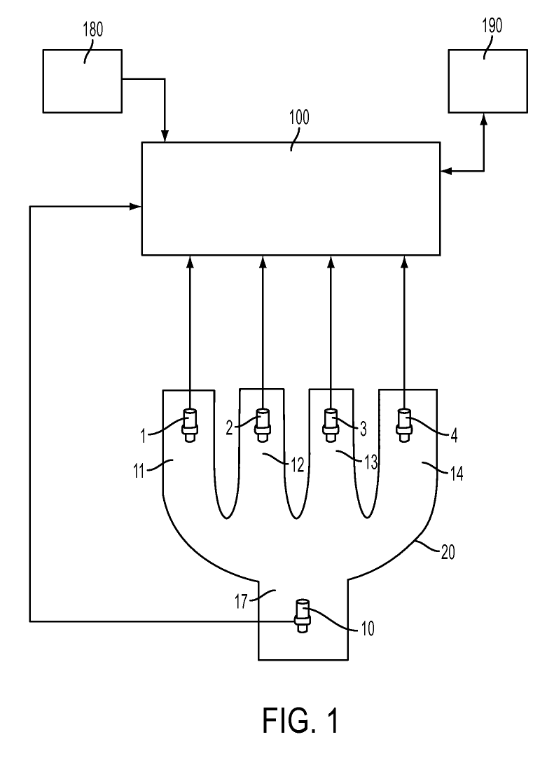

FIG. 1 illustrates an example schematic representation of an exhaust system constructed in accordance with the disclosed principles. The exemplary exhaust system includes an exhaust manifold 20 have a first exhaust runner 11, second exhaust runner 12, third exhaust runner 13, and fourth exhaust runner 14. Each individual exhaust runner 11, 12, 13, 14 is coupled to the exhaust port of a corresponding engine cylinder (not shown). Further, each exhaust runner 11, 12, 13, 14 includes an oxygen sensor 1, 2, 3, 4 provided therein. That is, the first exhaust runner 11 includes a first oxygen sensor 1, the second exhaust runner 12 includes a second oxygen sensor 2, the third exhaust runner 13 includes a third oxygen sensor 3, and the fourth exhaust runner 14 includes a fourth oxygen sensor 4. The oxygen sensors 1, 2, 3, 4 are wide range oxygen sensors as understood by one of ordinary skill in the art. In one embodiment, switching, or other types of oxygen sensors may be used. The individual exhaust runners 11, 12, 13, 14 join together at the confluence 17 of the exhaust runners. A switching oxygen sensor or wide range oxygen sensor 10 (“oxygen sensor 10”) is located at or downstream of the confluence 17 of the exhaust runners.

In one embodiment, the confluence 17 of the exhaust runners is the point at which all of the individual exhaust runners 11, 12, 13, 14 are joined together. In one embodiment, one or more of the individual exhaust runners 11, 12, 13, 14 may join with a second of the individual exhaust runners 11, 12, 13, 14 separately from the other individual exhaust runners 11, 12, 13, 14. In this embodiment, the confluence of the individual exhaust runners 11, 12, 13, 14 is the point at which the exhaust gas flow from all of the individual exhaust runners 11, 12, 13, 14 flows through a single exhaust pipe. In one embodiment, the oxygen sensor 10 is installed at or downstream of the confluence 17 of the exhaust runners but upstream of a catalytic converter. In one embodiment, an engine having multiple banks of engine cylinders includes one exhaust manifold 20, one confluence 17 of the exhaust runners, and one oxygen sensor 10 per bank of engine cylinders. In one embodiment, an engine having multiple banks of engine cylinders includes more than one exhaust manifold 20, more than one confluence 17 of the exhaust runners, and one oxygen sensor 10 per confluence 17.

The oxygen sensors 1, 2, 3, 4, 10 are connected to an on board electronic system (“electronic system”) 100. The electronic system 100 may be an engine electronic control unit or any other control unit or computer onboard the vehicle. The electronic system 100 is in communication with vehicle sensors 180 that provide data to the electronic system 100 regarding the operating conditions of the engine and the vehicle. The vehicle sensors 180 may include, but are not limited to, engine RPM, intake manifold air pressure, crankshaft position, cam position, coil packs, temperature, and any other sensors known to one of skill in the art. The electronic system 100 is also in communication with select vehicle control parameters 190 that may be adjusted and controlled by the electronic system 100. The vehicle control parameters 190 may include, but are not limited to, fuel injectors, coil packs, throttle body, and any other adjustable or controllable parameters one of skill in the art may adjust or control in association with an engine or vehicle.

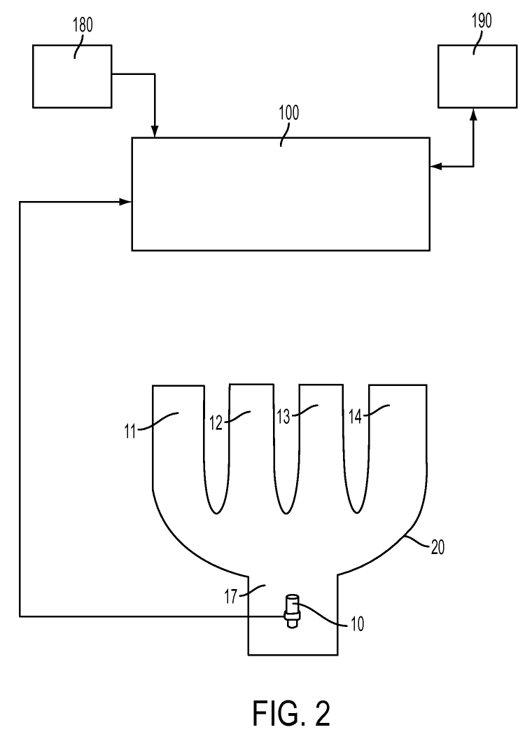

FIG. 2 illustrates an example schematic representation of an exhaust system according to another embodiment disclosed herein. The exhaust system of FIG. 2 is identical to that of FIG. 1 except that the oxygen sensors 1, 2, 3, 4 of the exhaust system of FIG. 1 are omitted from the exhaust system of FIG. 2.

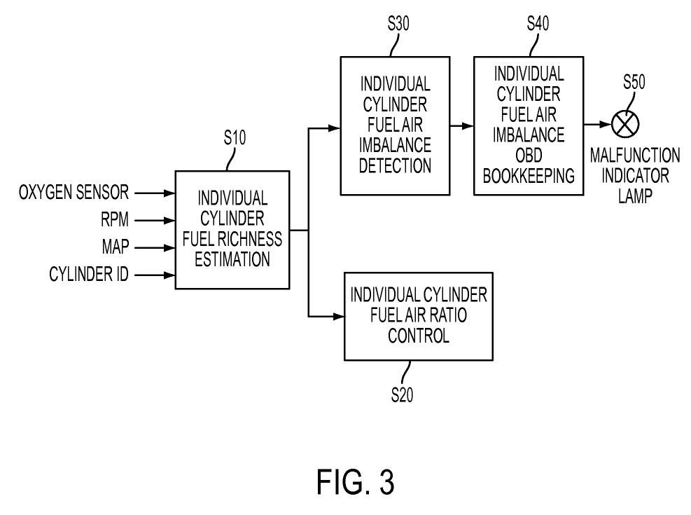

FIG. 3 is a flowchart showing an exemplary fuel air ratio estimation method in accordance with disclosed principles. The method is generally based on a virtual sensing concept as illustrated in FIG. 2. For each cylinder in the engine, a fuel air ratio estimator is assembled using an oxygen sensor 10 signal as its input. The estimators have parameters that are determined or calibrated based on the true measurements of the actual fuel air ratio of each engine cylinder using oxygen sensors 1, 2, 3, 4 in each exhaust runner 11, 12, 13, 14 as illustrated in FIG. 1. In some embodiments, the oxygen sensors 1, 2, 3, 4 may be used only for calibration and not used in actual production vehicles.

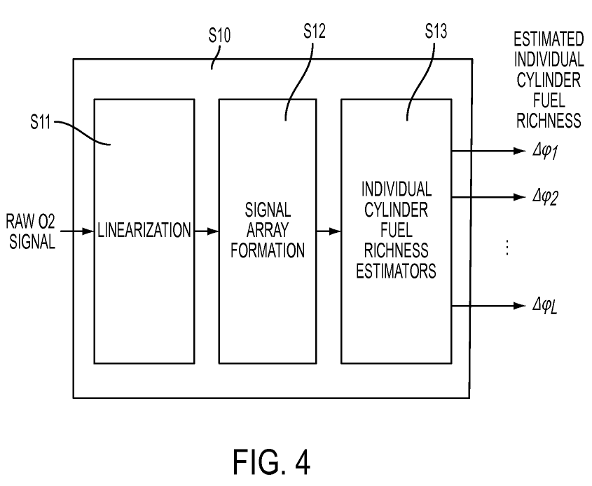

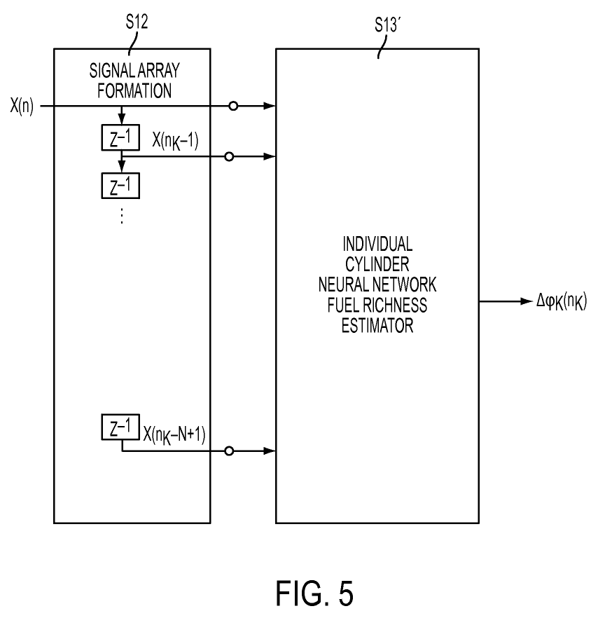

In the method of FIG. 3, signals from the oxygen sensor 10 (“oxygen sensor”), engine RPM (“RPM”), the air pressure in the engine's intake manifold (“MAP”), and crankshaft position (“cylinder ID”) are input. At step S10, the individual cylinder fuel richness estimation is performed using the input parameters. The individual cylinder fuel richness estimation step S10 is discussed in greater detail below with reference to FIGS. 4 and 5. After the individual cylinder fuel richness estimation is performed (step S10), the results are utilized to control the fuel air ratio for each of the engine cylinders (step S20). In one embodiment, the fuel air ratio of the engine cylinders may be controlled individually. In one embodiment, the results from step S10 are used by the electronic system 100 to adjust the vehicle control parameters 190 to permit more air or less fuel into an engine cylinder that is running rich (greater amount of fuel versus air than the stoichiometric ratio) and less air or more fuel into an engine cylinder that is running lean (greater amount of air versus fuel than the stoichiometric ratio) to achieve a desired fuel air ratio for each cylinder. In one embodiment, the results from step S20 are used by the electronic system 100 to adjust the fuel air ratio of the engine cylinders to balance the fuel air ratio of the cylinders relative to each other or some other desired ratio rather than the stoichiometric ratio. Also after the individual cylinder fuel richness estimation is performed (step S10), the results are utilized to determine whether an imbalance exists between the fuel air ratio of the individual engine cylinders (step S30). In one embodiment, an imbalance may be determined to exist where the difference of the fuel air ratio from the lowest ratio to highest ratio cylinder exceeds a predetermined threshold. The predetermined threshold may be dependent on government fuel emission regulations. In one embodiment, the threshold may be approximately 15% fuel richness or leaness. In one embodiment, an imbalance may be determined to exist where the standard deviation from the desired fuel air ratio exceeds a predetermined threshold. The predetermined threshold may be dependent on government fuel emission regulations. The predetermined threshold is dependent upon the particular engine and exhaust system used. In one embodiment, any desired metric may be used to determine whether an imbalance exists.

After imbalance detection (step S30), the electronic system 100 records the presence of any imbalance (step S40). In one embodiment, the electronic system 100 may keep a running record of the fuel air ratio of the individual cylinders and/or any imbalance between the cylinders. In the event the fuel air ratio exceeds a predetermined threshold, a vehicle operator may be notified of the imbalance by a warning light, chime, or any other method (step S50). In one embodiment, a vehicle operator is warned of the fuel air ratio imbalance if the imbalance exceeds one of the predetermined thresholds. In one embodiment, the vehicle operator is warned if one of the predetermined thresholds is exceeded on a single run cycle of the engine. In one embodiment, the vehicle operator is warned only after one of the predetermined thresholds is exceeded on more than one run cycles of the engine. In one embodiment, the warning light may be triggered only for the duration of the imbalance.

In discussing the fuel air ratio, a normalized fuel air ratio is more convenient to use than the fuel air ratio itself. The normalized fuel ratio may be calculated by multiplying the measured fuel air ratio by 14.64. A normalized fuel air ratio of one indicates the fuel air ratio is at the stoichiometric value. A normalized fuel ratio greater than one indicates there is a greater percentage of fuel to air than the stoichiometric ratio. A normalized fuel ratio less than one indicates there is a greater percentage of air to fuel than the stoichiometric ratio. A fuel richness estimation is used to estimate the deviation of the normalized fuel air ratio from the stoichiometric value. The fuel richness estimation may be calculated by use of the following equation:

Fuel Richness(%)=ΔΦ=(Φ−1)×100=[14.64×(F/A)−1]×100 (Eq. 1)

In Equation 1, 14.64×(F/A) is the normalized fuel air ratio, where “F/A” is the fuel air ratio. When ΔΦ=0, the fuel air ratio is balanced at the stoichiometric ratio. When, ΔΦ>0, the fuel air ratio contains a higher proportion of fuel to air than the stoichiometric ratio (“rich”). Where ΔΦ<0, the fuel air ratio contains a higher proportion of air to fuel than the stoichiometric ratio (“lean”).

FIG. 4 is a flowchart showing an exemplary individual cylinder fuel richness estimation step S10 of the method of FIG. 3. The first substep in the individual cylinder fuel richness estimation step S10 is to linearize the signal from the oxygen sensor 10 (step S11). Two types of oxygen sensors typically used in the automotive applications: switching oxygen sensors and wide range oxygen sensors. Generally, automotive applications utilize switching oxygen sensors as they are lower cost than wide range oxygen sensors. However, manufacturers are increasingly beginning to utilize wide range oxygen sensors. When an engine operates in closed loop fuel control, the switching oxygen sensor signal output is a wave form of a sinusoid type. If the fuel air ratio of all individual cylinders is balanced and no fuel richness is induced, the oxygen sensor signal output switching wave is smooth. However, if one cylinder in the bank of engine cylinders is running rich or lean, the oxygen sensor signal output switching wave is no longer smooth and becomes distorted. The oxygen sensor signal output switching wave becomes increasingly distorted as the rich or lean condition of the cylinder increases in magnitude. At a 20% rich or lean condition, the oxygen sensor signal output switching wave has become so severely distorted that it becomes difficult to identify. In some cases, the oxygen sensor signal output switching wave may become severely distorted at a 20% rich or lean condition. In contrast to a switching oxygen sensor, a wide range oxygen sensor exhibits less distortion during rich or lean conditions than a switching oxygen sensor. Further, a wide range oxygen sensor tends to exhibit a more linear relationship to the fuel air ratio than a switching oxygen sensor and does not exhibit switching waves.

In one embodiment of the method, the oxygen sensor 10 is a wide range oxygen sensor. In another embodiment, the oxygen sensor 10 is a switching oxygen sensor. Because of its inherent characteristics, a linearization process (step S11) is applied to the signal from the oxygen sensor 10 to improve estimation performance when a switching oxygen sensor is utilized. The linearization process (step S11) need not be applied to the signal from the oxygen sensor 10 when a wide range oxygen sensor is utilized. Where a wide range oxygen sensor is used, the individual cylinder fuel richness estimation step S10 begins with signal array formation (step S12).

In the linearization process (step S11), the inverse of the switching oxygen sensor's transfer function, a nonlinear function, is first obtained. Typically, this would be obtained from data from the manufacturer of the switching oxygen sensor showing the output voltage of the switching oxygen sensor versus the actual fuel air ratio. Alternatively, the function may be obtained by recording the actual output voltages of the switching oxygen sensor in response to known fuel air ratios and fitting a function to the resulting curve. In one embodiment, the function, i.e., linearized switching oxygen sensor signal, is expressed as:

x(n)=p(O2(n))=a₀+a₁(O2(n)−c)+ . . . +aₓ(O2(n)−c)^{Y} (Eq. 2)

In the above polynomial equation, “O2(n)” is the raw O2 signal, “n” is the sampling index, and “c” is a constant. The constant “c” represents the bias used for shifting the raw signal of the oxygen sensor 10 as would be understood by one of skill in the art. In one embodiment, the constant “c” equals −0.5. Further, “aᵢ”, where “i” is zero through X. X and Y are coefficients of the polynomial of Y degrees. Generating the polynomial as described above reduces the negative impact of the switching oxygen sensor's nonlinear characteristics on the fuel air ratio estimation.

After the linearization process (step S11) is complete, the linearized switching oxygen sensor voltage enters a signal array formation step S12. Where a wide range oxygen sensor is used, the linearization process (step S11) is skipped and the oxygen sensor voltage is directly passed into the signal array formation step S12. As discussed above, an imbalance in the fuel air ratio between multiple cylinders distorts the voltage signal from the oxygen sensor 10. This distortion is the result of high frequency signal components in the output signal of the oxygen sensor 10. The imbalance signal frequency ranges about from 5 to 60 Hz, depending on the number of engine cylinders the engine includes and the operating RPM of the engine. Also as discussed above, the severity of the distortion depends upon the degree of the imbalance between the fuel air ratio of the individual cylinders. The distorted/imbalance oxygen sensor 10 signal contains the information utilized by the method to estimate individual cylinder fuel richness. After the signal array is formed (step S12), the signal array enters the individual fuel richness estimator step S13.

FIG. 5 is a flowchart showing an exemplary system block for the signal array formation S12 and individual cylinder neural network fuel richness estimators S13′ of the method of FIG. 4. With reference to FIGS. 4 and 5, in step S12, the signal array formation block generates a signal array for input into the individual cylinder neural network fuel richness estimator S13′. The array in step S12 is formed from a plurality of temporal sampling points, each corresponding to a particular angular position of the crankshaft of the engine. In one embodiment, the position of the crankshaft may be determined by a crankshaft sensor. In one embodiment, the position of the crankshaft may be determined by a cam sensor or a combination of a crankshaft sensor and a cam sensor. To form the array, the wide range or switching oxygen sensor's 10 output is sampled in the crankshaft angular domain. That is, the wide range or switching oxygen sensor's 10 output is sampled as the crankshaft is at certain positions in its rotation. In one embodiment, the wide range or switching oxygen sensor's 10 output is sampled at top dead center (“TDC”) of each piston. In one embodiment, the wide range or switching oxygen sensor's 10 output is sampled at TDC of a piston corresponding to a particular engine cylinder. In one embodiment, the wide range or switching oxygen sensor's 10 output is sampled at TDC and also at bottom dead center (“BDC”) of each piston or of a piston corresponding to a particular cylinder. In the signal array formation for an individual engine cylinder, N data points, where N is an integer equal to or greater than 1, are taken from the current firing event corresponding to the cylinder for which the fuel air ratio is being estimated and also from the previous firing events corresponding to the same cylinder. The number of data points N is determined based upon the desired fuel richness estimation performance, i.e., level of accuracy, and the computational load allowed. In one embodiment, data is collected in the above-described manner for each engine cylinder. For example, if one data point were collected for each cylinder in a 6 cylinder engine, the number of data points, N, would be equal to 6 If two data points were collected for each cylinder in a 6 cylinder engine, the number of data points, N, would be equal to 12. In one embodiment, data is collected in the above-described manner for only a desired engine cylinder or cylinders. Mathematically, the signal array for a particular cylinder's, in this case “k,” fuel richness estimation can be written as the following vector:

X(nₖ)=[x(nₖ)x(nₖ−1) . . . x(nₖ−N+1) 1] (Eq. 3)

In the above equation, x(nₖ−j), where j=0, 1, . . . N−1, are the linearized oxygen sensor signals if a switching oxygen sensor is used or the wide range oxygen sensor signals if a wide range oxygen sensor is used. The oxygen sensor signals are sampled at predetermined and constant angular positions of the engine's crankshaft, as discussed above. A total of “N” samples are taken, where “N” is an integer as described above. In one embodiment, “N” is equal to the number of engine cylinders. In the above equation, x(nₖ) (i.e., where j=0) is the signal sampled from the oxygen sensor 10 at cylinder k's sampling period. In one embodiment, the sampling period for cylinder k is when it is at TDC. The terms x(nₖ−j), where j=1, . . . N−1, represent previous sample points of the wide range or switching oxygen sensor's 10 output from cylinder k. In the vector, the constant “1” is included as a bias for better estimation performance. Thus, x(nₖ) is the current sample of the wide range or switching oxygen sensor's 10 output for cylinder k, x(nₖ−1) is the previous sample of the wide range or switching oxygen sensor's 10 output for cylinder k, and x(nₖ−J) is the j previous samples ago of the wide range or switching oxygen sensor's 10 output for cylinder k. In one embodiment, the constant “1” may be omitted. Further, “z⁻¹” is a unit delayer that delays the input one sample period. As described above, the current array vector of cylinder “k” is (X(nₖ)). The previous array vector of cylinder “k” is X(nₖ−mN_{cyl}) rather than X(nₖ−1), where N_{cyl} is the number of engine cylinders of the engine and “m” is the number of sampling points for each cylinder.

The signal array vector formed in step S12 is then input into the individual cylinder fuel richness estimator step S13. In the embodiment of FIG. 5, the individual cylinder fuel richness estimator (step S13) is an individual cylinder neural network fuel richness estimator (step S13′) that uses a neural network to estimate the richness of individual engine cylinders. The neural network includes a bias element (not shown) of a type that would typically be included in a neural network. To improve the neural network's estimation performance, the signal from each array element is filtered using a low-pass filter to remove undesired noise. The filtered signals are then fed into a feedforward neural network. In one embodiment, a program, such as MATLAB®'s Neural Network Toolbox, is utilized to train and evaluate the neural network. In one embodiment, a custom designed or any other commercially available neural net program may be utilized. Utilizing a program, such as MATLAB®'s Neural Network Toolbox, multiple training strategies and methods can be selected to easily configure the neural network with different layers and learning parameters for best estimation performance. To construct the neural network, the exhaust system of FIG. 1 is utilized. Measurements from the wide range oxygen sensors 1, 2, 3, 4 are compared to the output of the neural network fuel richness estimator and used to determine the coefficients of neural network fuel richness estimator.

In one embodiment, the neural network fuel richness estimator is configured to have one hidden layer. In one embodiment, one or more tan-sigmoid neurons are used. In one embodiment, any type and number of neurons may be used. In one embodiment, a MATLAB® provided Levenberg-Marquardt algorithm may be used for training the neural network. In one embodiment, any type of algorithm may be used for training the neural network.

One disadvantage of neural networks is that they typically require large computational resources. Moreover, the learning process for the network is time consuming. The large computational power demands and learning process may, but need not necessarily, limit the use of neural networks in production vehicles. Thus, while neural networks may be utilized in the method of the present invention, an alternative method for performing the individual cylinder fuel richness estimation (step S13) is also disclosed.

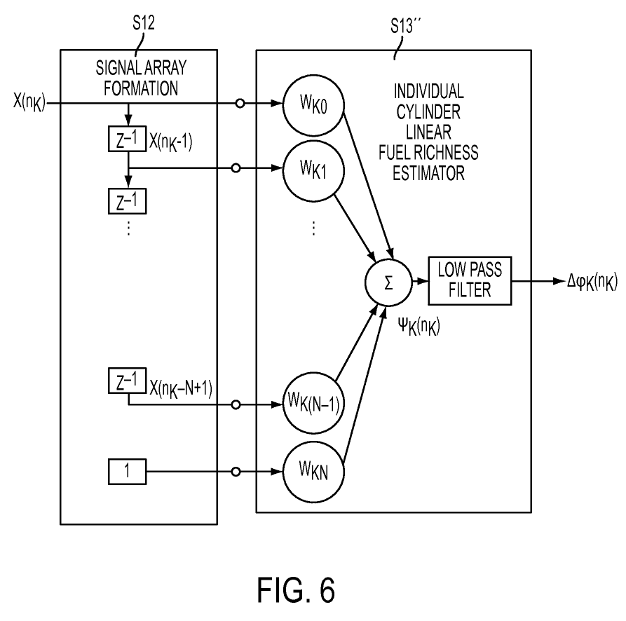

FIG. 6 is a flowchart showing an exemplary system block for the signal array formation step and an individual cylinder linear fuel richness estimators step of the method of FIG. 4. As discussed above with reference to FIGS. 4 and 5, in step S12, the signal array formation block generates a signal array for input into the individual cylinder fuel richness estimator (step S13). In the embodiment of FIG. 6, the individual cylinder fuel richness estimator (step S13) is an individual cylinder linear fuel richness estimator (step S13″) that uses a linear estimator to estimate the richness of individual engine cylinders. The individual cylinder linear fuel richness estimator (step S13″) requires less computing power than the individual cylinder neural network fuel richness estimator (step S13′), thus, making it potentially more easily adaptable for use in production vehicles. In the individual cylinder linear fuel richness estimator (step S13″) of FIG. 6, each element of the input array X(nₖ) is multiplied by a weight. The products are added together. The linear fuel richness estimator for a cylinder “k” can be expressed as follows:

Ψₖ(nₖ)=wₖₒx(nₖ−1)+ . . . +wₖ(N−1)x(nₖ−N+1)+W_{kN} (Eq. 4)

In the above equation, x(nₖ−j), where x(nₖ) is taken from Equation 3. Further, wₖⱼ, where j=0, 1, . . . , N, denotes the estimator's weighs. “N” is an integer of the same value as in Equation 3. The coefficients or weights of the individual cylinder linear fuel richness estimator may be determined using the least squares method. Alternatively, the coefficients or weights of the individual cylinder linear fuel richness estimator may be determined using any other curve fitting or equation generating method desired. To determine the coefficients, the exhaust system of FIG. 1 is utilized. Measurements from the wide range oxygen sensors 1, 2, 3, 4 are compared with the signal array vector S12 formed using data from the oxygen sensor 10. A curve is generated (step S13″) to make the signal array vector (step S12) formed using data from the oxygen sensor 10 correspond with the wide range oxygen sensors 1, 2, 3, 4. Fitting a curve to this data is simpler and consumes less time and computing power than using the neural network of (step S13′).

The sum of Equation 4 is sent to a signal filter for smoothing and noise removal. In one embodiment, the signal filtering is performed by a low pass filter. In one embodiment, any type of signal filter may be used. In one embodiment, the low pass filtering is performed by an exponential filter using the following equation:

ΔΦₖ(nₖ)=(1−α)ΔΦₖ(nₖ−1)+αΨₖ(nₖ) (Eq. 5)

In the above equation, α is the filter coefficient of the exponential filter and Ψₖ(nₖ) is the output from Equation 4. In one embodiment, α= 1/32. In one embodiment, α> 1/32 or α< 1/32. In one embodiment, any type of low pass filtering may be performed.

The algorithm of the individual cylinder linear fuel richness estimator (step S13″) requires (N+2) multipliers and (N+1) additions for each cylinder of the engine per engine cycle. If one data point is taken in each engine cycle, i.e., m=1, and N=N_{cyl}, where N_{cyl} is equal to the number of engine cylinders, then the individual cylinder linear fuel richness estimator (step S13″) requires only (N_{cyl}+2) multipliers and (N_{cyl}+1) additions. For example, a v6 (Le., six cylinder) engine would require 8 multipliers and 7 additions for each cylinder (k) per engine cycle. If a 5 degree polynomial is used, each new added data point requires 9 multipliers and 6 additions.

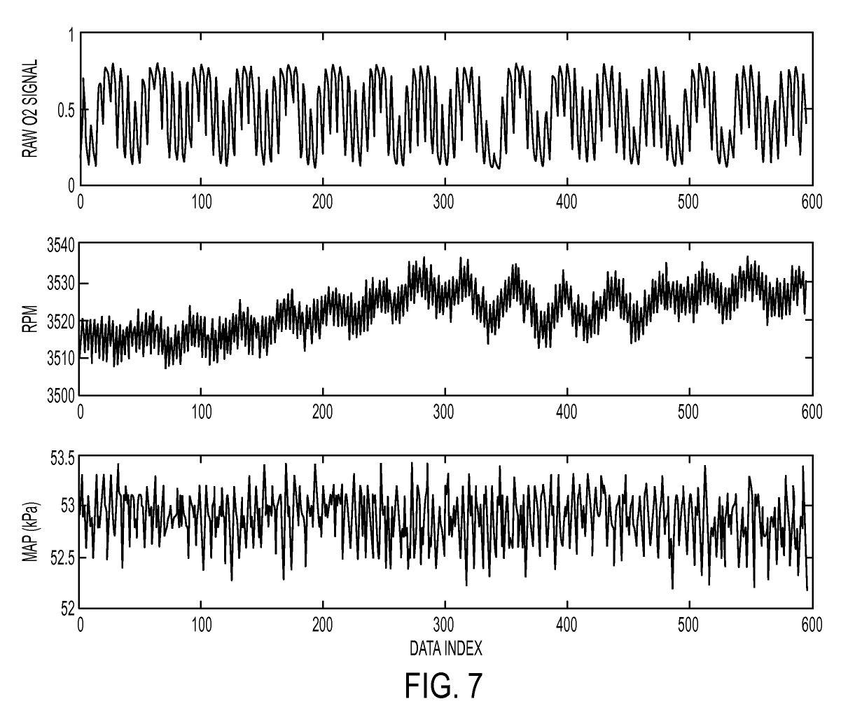

FIG. 7 is a plot showing oxygen sensor, engine RPM, and manifold pressure signals for an exemplary engine. The oxygen sensor of FIG. 7 is a switching oxygen sensor. The exemplary engine of Figure is a v6 engine. The exemplary engine includes two cylinder banks, each having an exhaust manifold. A first cylinder bank includes cylinders 1, 3 and 5, and a second cylinder bank includes cylinders 2, 4 and 6. A single switching oxygen sensor was installed at the confluence point of the exhaust runners of engine cylinders 2, 4, 6 of the second bank to estimate fuel richness. A wide range oxygen sensor was installed in the individual exhaust runner for each cylinder of the second cylinder bank to determine the actual fuel richness of each cylinder and, thereby, develop the fuel richness estimator. Thus, a single wide range oxygen sensor was installed in the exhaust runner for cylinder 2, a single wide range oxygen sensor was installed in the exhaust runner for cylinder 4, and a single wide range oxygen sensor was installed in the exhaust runner for cylinder 6.

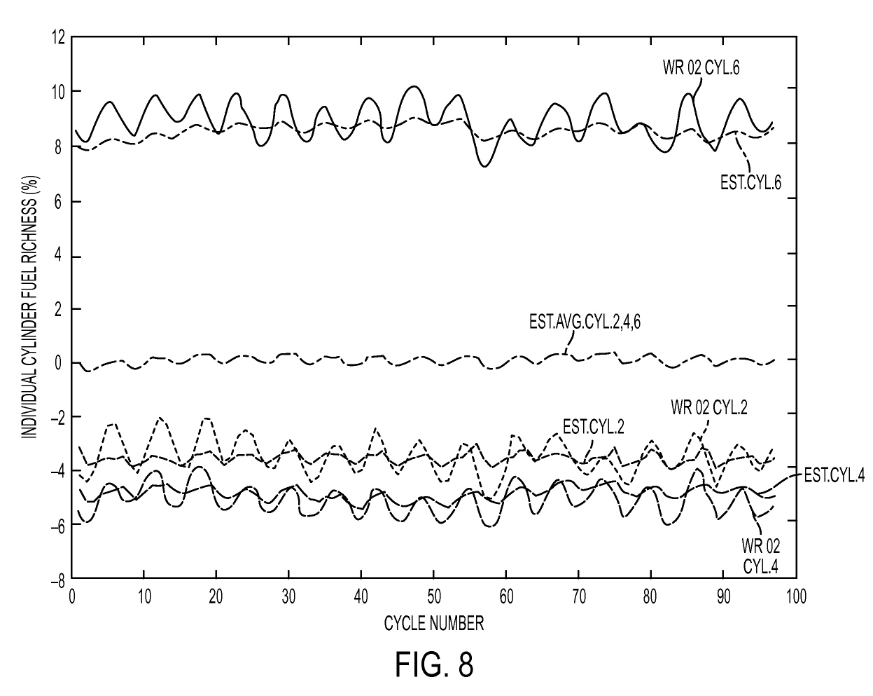

FIG. 8 is a plot showing the estimated and actual individual cylinder fuel richness of engine cylinders 2, 4, 6 of the engine of FIG. 7 using the method of FIGS. 3, 4 and 6. The estimated fuel richness of FIG. 8 was calculated using the individual cylinder linear fuel richness estimator (step S13″). The estimated fuel richness calculated using the individual cylinder neural network fuel richness estimator (step S13′) closely mirrors that of the individual cylinder linear fuel richness estimator (step S13″). The actual individual cylinder fuel richness of each cylinder was measured using the wide range oxygen sensors positioned in the exhaust runner for each of engine cylinders 2, 4, 6. As can be seen, the estimated fuel richness for each cylinder closely tracks the actual fuel richness.

In one embodiment, any number of engine cylinders may be included with the engine. Moreover, the engine cylinders and exhaust runners may be configured in any desired arrangement. It should be appreciated that the present disclosure is not limited to the particular mechanical configuration described herein. In one embodiment, the individual cylinder neural network fuel richness estimator (step S13′) offers better training performance but worse evaluation (i.e., actual estimation performance) than the individual cylinder linear fuel richness estimator (step S13″). However, when an individual cylinder neural network fuel richness estimator (step S13′) having a single linear neuron is used, the performance between the individual cylinder neural network fuel richness estimator (step S13′) and the individual cylinder linear fuel richness estimator (step S13″) is similar.

In one embodiment, because of the presence of the oxygen sensors 1, 2, 3, 4, the exhaust system of FIG. 1 is only used for initial setup and tuning of the method. For instance, the system of FIG. 1 may be installed on one vehicle or exhaust system/engine combination of a particular type for initial setup purposes of the method only. In contrast, the exhaust system of FIG. 2 may be installed on production vehicles for use with the programmed method of the exhaust system of FIG. 1. Removing the oxygen sensors 1, 2, 3, 4 as in the exhaust system of FIG. 2 reduces production costs by eliminating the costs of the oxygen sensors 1, 2, 3, 4. In addition, removing oxygen sensors 1, 2, 3, 4 reduces assembly and fabrication costs.

Thus, a method of measuring the fuel air ratio of each cylinder that effectively estimates the fuel air ratio of individual cylinders from the measurement of an oxygen sensor located at the confluence point of the runners is described. The method is compatible with both a wide range oxygen sensor and a switching oxygen sensor. The method directly estimates the value of the fuel air ratio for each cylinder, is compatible with vehicle on board diagnostics, and includes a simplified calibration process. The method accurately estimates the fuel air ratio for each cylinder and requires reduced computing power to complete the estimation, rendering the method simpler and more effective than prior art methods. The method is capable of adjusting the fuel air ratio for individual engine cylinders and of individual cylinder fuel air ratio imbalance control.

What is claimed is:

1. A method of estimating fuel richness of a plurality of engine cylinders, comprising:
providing a first oxygen sensor at a confluence of a plurality of exhaust runners associated with said engine cylinders;
gathering data regarding an actual fuel air ratio at said confluence of said plurality of exhaust runners using said first oxygen sensor;
forming a signal array for each of said plurality of engine cylinders using said data gathered by said first oxygen sensor; and
calculating individual fuel richness for each of said plurality of engine cylinders using an individual cylinder fuel richness estimator.

2. The method of claim 1, further comprising determining an angular position of a crankshaft of said engine, wherein said signal array for a particular cylinder comprises data gathered when said crankshaft is at a predetermined rotational position unique to said cylinder.

3. The method of claim 1, further comprising linearizing the signal from said first oxygen sensor prior to forming said signal array if said first oxygen sensor is a switching oxygen sensor.

4. The method of claim 1, wherein said first oxygen sensor is provided between the confluence of the exhaust runners and a catalytic converter.

5. The method of claim 1, wherein the step of calculating the individual fuel richness for each of said plurality of engine cylinders further comprises using a neural network to calculate the individual fuel richness for each of said plurality of engine cylinders.

6. The method of claim 1, wherein the step of calculating the individual fuel richness for each of said plurality of engine cylinders further comprises using a linear estimator to calculate the individual fuel richness for each of said plurality of engine cylinders.

7. The method of claim 6, further comprising using a signal filter to smooth and remove noise from said calculated individual cylinder fuel richness for each of said plurality of engine cylinders.

8. The method of claim 1, further comprising adjusting the fuel air ratio of each of said plurality of engine cylinders based upon said calculated individual fuel richness of said engine cylinder.

9. The method of claim 8, further comprising:
determining whether an imbalance between a fuel richness of a first of said plurality of engine cylinders and a fuel richness of a second of said plurality of engine cylinders exceeds a predetermined amount; and
recording the existence of said imbalance if said imbalance between said fuel richness of the first of said plurality of engine cylinders and said fuel richness of the second of said plurality of engine cylinders exceeds said predetermined amount.

10. The method of claim 1, further comprising:
providing a plurality of calibration oxygen sensors, wherein each of said exhaust runners includes at least one calibration oxygen sensor;
gathering data from said calibration oxygen sensors regarding the actual fuel air ratio in each of said exhaust runners; and
utilizing said data from said calibration oxygen sensors and said first oxygen sensor to create said individual cylinder fuel richness estimators.

11. A method of estimating fuel richness of an engine, comprising:
providing a first oxygen sensor at a confluence of a plurality of exhaust runners associated with a plurality of engine cylinders;
determining an angular position of a crankshaft of said engine;
gathering data regarding an actual fuel air ratio at said confluence of said plurality of exhaust runners using said first oxygen sensor when said crankshaft is at a predetermined rotational position, wherein said data gathered at said predetermined rotational position corresponds to one of said plurality of engine cylinders;
forming a signal array for each of said plurality of engine cylinders using said corresponding data gathered by said first oxygen sensor; and
calculating an individual fuel richness for each of said plurality of engine cylinders using an individual fuel richness estimator.

12. The method of claim 11, further comprising linearizing the signal from the first oxygen sensor prior to forming said signal array if said first oxygen sensor is a switching oxygen sensor.

13. The method of claim 11, wherein said first oxygen sensor is provided between the confluence of the exhaust runners and a catalytic converter.

14. The method of claim 11, wherein said signal array for a particular engine cylinder comprises a plurality of data points corresponding to said engine cylinder.

15. The method of claim 14, further comprising adjusting the fuel air ratio of each of said plurality of engine cylinders based upon the calculated individual fuel richness of said engine cylinder.

16. The method of claim 11, wherein the step of calculating the individual fuel richness for each of the plurality of engine cylinders further comprises using a neural network to calculate the individual fuel richness for each of the plurality of engine cylinders.

17. The method of claim 16, wherein the neural network comprises at least one hidden layer and at least one single tan-sigmoid neuron.

18. The method of claim 11, wherein the step of calculating the individual fuel richness for each of the plurality of engine cylinders further comprises:
using a linear estimator to calculate the individual fuel richness for each of said plurality of engine cylinders; and
using a signal filter to smooth and remove noise from said calculated individual cylinder fuel richness for each of said plurality of engine cylinders.

19. The method of claim 18, further comprising:
adjusting the fuel air ratio of each of said plurality of engine cylinders based upon said calculated individual fuel richness for each of said plurality of engine cylinders;
determining whether the imbalance between the fuel richness of a first of said plurality of engine cylinders and a second of said plurality of engine cylinders exceeds a predetermined amount;
recording the existence of the imbalance if said imbalance between the fuel richness of the first of said plurality of engine cylinders and the fuel richness of the second of said plurality of engine cylinders exceeds said predetermined amount; and
providing a warning if said imbalance between the fuel richness of the first of said plurality of engine cylinders and the fuel richness of the second of said plurality of engine cylinders exceeds said predetermined amount.

20. The method of claim 11, further comprising:
providing a plurality of calibration oxygen sensors, wherein each of said exhaust runners includes at least one calibration oxygen sensor;
gathering data from said calibration oxygen sensors regarding the actual fuel air ratio in each of said exhaust runners; and
utilizing said data from said calibration oxygen sensors and said first oxygen sensor to create said individual cylinder fuel richness estimators.
